(19) United States
(12) Patent Application Publication
(10) Pub. No.: US 2011/0070567 A1
(43) Pub. Date: Mar. 24, 2011

(54) SYSTEM FOR PROFESSIONAL DEVELOPMENT TRAINING, ASSESSMENT, AND AUTOMATED FOLLOW-UP

(76) Inventor: Chet Linton, Midvale, UT (US)

(21) Appl. No.: 12/776,161

(22) Filed: May 7, 2010

Related U.S. Application Data
(63) Continuation-in-part of application No. 09/945,246, filed on Aug. 31, 2001.
(60) Provisional application No. 60/229,206, filed on Aug. 31, 2000.

(51) Int. Cl. G09B 19/00

(52) U.S. Cl. 434/219

(57) ABSTRACT

Systems and methods for providing web-enabled professional development training to participants in diverse industries to thereby improve the participant's knowledge, skills, and proficiency. Professional development training is provided over the Internet. Following the training, at least one participant is provided with a first question set regarding the training. The participant is then allowed to implement concepts and principles according to the training previously received. After a predetermined period of time elapses, additional follow-up questions are generated based on the participant's responses to the first question set and the participant's implementation of training principles and concepts. The follow-up questions may then be presented to the participant via the Internet. In a further implementation, the follow-up questions may be presented to a supervisor of the participant. In some implementations, the Internet may be utilized to assess the participants performance prior to and after receiving training.

### CROSS-REFERENCE TO RELATED APPLICATIONS

This application is a continuation-in-part of prior application Ser. No. 09/945,246, filed Aug. 31, 2001, which claims the benefit of U.S. Provisional Application No. 60/229,206, filed Aug. 31, 2000.

### BACKGROUND OF THE INVENTION

1. Field of the Invention

The present invention relates to professional development training. In particular, the present invention relates to systems and methods for providing web-based professional development training to persons employed in diverse industries to thereby improve their professional knowledge, skills, and proficiency.

2. Background and Related Art

A majority of industries that require professional development have curriculums and/or standards outlining the objectives for persons employed in those industries. Some industries even base employees' salaries or continued employment on evaluations of the successful implementation and achievement of such standards. In one non-limiting example, in an academic setting for instance, if teachers fail to provide instruction at the level required by the federal, state or regional school required level, and their students demonstrate deficiencies in certain areas, the teachers' job or salary may be affected. In another non-limiting example, in a corporate setting for instance, if directors, managers or officers fail to provided corporate management services at the level required by the federal, state or regional government and/or corporate bylaws and articles, the corporate professionals' jobs or salaries may be affected.

Unfortunately, despite often pervasive federal, state or regionally mandated standards, there is frequently insufficient supervision across various industries to ensure such standards are implemented and achieved. In addition, there is often little guidance available for persons employed within such industries as to how to implement those standards.

Furthermore, there are many areas in which to train persons employed across various industries. For instance, training in leadership, interpersonal skills, discipline, communication skills, managerial skills, organizational skills, or even in the basic subject matter of the employee's job is often a necessity for an employee to implement and achieve industry standards successfully. However, another drawback with respect to employee improvement results when industries or employers only focus on a single element for improvement of their employees, because budgetary restraints preclude focusing on more than one area. This limits industries or employers in their ability to train or improve in more than one area. As a consequence, though necessity calls for improvement in more than one area, industries or employers end up choosing one area, among many, for training their employees even though a broad base of training is necessary.

Yet another drawback with current techniques of professional development occurs when administrators want employees to focus on one area of professional development, while employees, other industry members or the public desires development of employees in another area. This fragmented approach to training may result in employees receiving training in areas that they oftentimes feel are unnecessary or unproductive. Also, such a fragmented approach in training may not improve the quality of the employee's work product, which is the ultimate goal.

Thus, while techniques currently exist that are used to evaluate and improve the professional skills, knowledge, and proficiency of persons employed in diverse industries, challenges still exist, including those previously mentioned. Accordingly, it would be an improvement in the art to augment or even replace current techniques with other techniques.

### BRIEF SUMMARY OF THE INVENTION

The present invention relates to professional development training. In particular, the present invention relates to systems and methods for providing web-based professional development training to persons employed in diverse industries to thereby improve their professional knowledge, skills, and proficiency.

Implementation of the present invention takes place in association with professional development training. In at least one implementation, the present invention relates to a web-enabled system for teaching skills to participants, assisting participants in integrating and applying those skills to their profession, assessing the success of participants in applying the skills, and evaluating whether or not additional training is necessary. By way of example only, in such implementations, the present invention may be used to improve the skills of health care professionals such as nurses or physicians, legal professionals such as lawyers, judges or trustees, corporate professionals such as officers, directors, managers or other internal corporate employees, travel industry professionals such as pilots, drivers, skippers or the like, educational professionals such as teachers or professors, financial professionals such as accountants, brokers, traders, tax specialists or the like, human relations professionals, sales professionals, service industry professionals, government employees, or any other workforce that requires professional training and assessment as to the assimilation and effectiveness of such training.

More particularly, in at least one implementation, a method for professional development includes providing training over the Internet to an employee or other participant. The training teaches skills in accordance with measurable industry standards. After a participant receives such training, the participant is allowed to access a development matrix via the Internet which incorporates the skills previously learned. The matrix is adapted to further improve the participant's mastery of the skills previously learned in accordance with industry standards. The matrix may also provide additional interactive materials to further enhance participant learning. Following on-line employment of the development matrix, the participant is allowed to perform his or her professional responsibilities according to the training previously received. The success of the training is then evaluated based on the participant's implementation of training principles and achievement of industry standards. The participant may then subsequently use the evaluations to improve his or her performance. The participant may receive additional training and progress through this cycle repeatedly as necessary.

In a further implementation, a method for professional development again includes providing training over the Internet to an employee or other participant. After the participant has completed the Internet based training, a set of questions related to the training may be submitted to the participant. Once again, the participant is then allowed to perform his or her professional responsibilities according to the training previously received. Afterward, additional follow-up questions may be generated automatically and subsequently submitted to the participant and/or his or her supervisor. Throughout this process, the participant's professional performance may be monitored via the Internet both before and after receiving the Internet based training to assess the participant's implementation of training principles. If the responses to the question sets provided and the assessment of the participant's implementation of the training reveal that the participant is deficient in certain areas, this signals that the participant may need more training in those areas. Again, the participant may receive additional training and progress through this cycle repeatedly as necessary.

In some implementations, the present invention may be employed on a computer system or in connection with a networked system. Accordingly, some aspects of the present invention make take place in association with computer devices, computer readable media, mass electronic storage devices, processing systems, servers, and any necessary interfaces to accommodate such systems. Likewise, some aspects of the present invention may take place in association with a communication media and/or other electronic media.

While the methods and processes of the present invention have proven to be particularly useful in the area of professional development, those skilled in the art can appreciate that the methods and processes can be used in a variety of different applications and in a variety of different industries to yield enhanced vocational development, including skills, knowledge and proficiency. For example, the methods and processes described herein may be used to improve the vocational development of laborers, craftsmen, artisans, production workers, and the like.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be clear from the description, as set forth hereinafter.

### BRIEF DESCRIPTION OF THE SEVERAL VIEWS OF THE DRAWINGS

In order that the manner in which the above-recited and other advantages and objects of the invention are obtained, a more particular description of the invention briefly described above will be rendered by reference to specific embodiments thereof, which are illustrated in the appended drawings. Understanding that the drawings depicts only typical embodiments of the invention and are therefore not to be considered limiting of its scope, the invention will be described with additional specificity and detail through the use of the accompanying drawings in which:

FIG. 1 is a representative system for implementing embodiments of the invention;

FIG. 2 is a representative networked system configuration that may be used in association with embodiments of the present invention;

FIG. 3 is a flow chart showing the various segments of the improvement continuum integrating the system of the present invention;

FIG. 4 is a flow chart showing of an alternative embodiment of various segments of the improvement continuum integrating the system of the present invention;

FIG. 4A is a flow chart showing additional segments of the improvement continuum integrating the system of the present invention;

FIG. 4B is a flow chart showing alternative segments of the improvement continuum integrating the system of the present invention; and

FIG. 5 is a block diagram schematically illustrating a representative architecture for implementing embodiments of the invention.

### DETAILED DESCRIPTION OF THE INVENTION

It is emphasized that the present invention, as illustrated in the figures and description herein, can be embodied in other forms. Thus, neither the drawings nor the following more detailed description of the various embodiments of the system and method of the present invention limit the scope of the invention. The drawings and detailed description are merely representative of the particular embodiments of the invention; the substantive scope of the invention should be determined by reference to the appended claims. The various embodiments of the invention will best be understood by reference to the drawings, wherein like elements are designated by like alphanumeric characters throughout.

The present invention relates to professional development training. In particular, the present invention relates to systems and methods for providing web-based professional development training to persons employed in diverse industries to thereby improve their professional knowledge, skills, and proficiency.

Embodiments of the present invention take place in association with professional development training. In at least one implementation, the present invention relates to a web-enabled system for teaching skills to participants, assisting participants in integrating and applying those skills to their profession, assessing the success of participants in applying the skills, and evaluating whether or not additional training is necessary. By way of example only, in such embodiments, the present invention may be used to improve the skills of health care professionals such as nurses or physicians, legal professionals such as lawyers, judges or trustees, corporate professionals such as officers, directors, managers or other internal corporate employees, travel industry professionals such as pilots, drivers, skippers or the like, educational professionals such as teachers or professors, financial professionals such as accountants, brokers, traders, tax specialists or the like, human relations professionals, sales professionals, service industry professionals, government employees, or any other workforce that requires professional training and assessment as to the assimilation and effectiveness of such training.

More particularly, in at least one embodiment, a method for professional development includes providing training over the Internet to an employee or other participant. The training teaches skills in accordance with measurable industry standards. After a participant receives such training, the participant is allowed to access a development matrix via the Internet which incorporates the skills previously learned. The matrix is adapted to further improve the participant's mastery of the skills previously learned in accordance with industry standards. The matrix may also provide additional interactive materials to further enhance participant learning. Following on-line employment of the development matrix, the participant is allowed to perform his or her professional responsibilities according to the training previously received. The success of the training is then evaluated based on the participant's implementation of training principles and achievement of industry standards. The participant may then subsequently use the evaluations to improve his or her performance. In such embodiments, the participant may receive additional training and progress through this cycle repeatedly as necessary.

In a further embodiment, a method for professional development again includes providing training over the Internet to an employee or other participant. After the participant has completed the Internet based training, a set of questions related to the training may be submitted to the participant. Once again, the participant is then allowed to perform his or her professional responsibilities according to the training previously received. Afterward, additional follow-up questions may be generated automatically and subsequently submitted to the participant and/or his or her supervisor. Throughout this process, the participant's professional performance may be monitored via the Internet both before and after receiving the Internet based training to assess the participant's implementation of training principles. If the responses to the question sets provided and the assessment of the participant's implementation of the training reveal that the participant is deficient in certain areas, this signals that the participant may need more training in those areas. Again, in such embodiments, the participant may receive additional training and progress through this cycle repeatedly as necessary.

In some embodiments, the present invention may be employed on a computer system or in connection with a networked system. Accordingly, some aspects of the present invention make take place in association with computer devices, computer readable media, mass electronic storage devices, processing systems, servers, and any necessary interfaces to accommodate such systems. Likewise, some aspects of the present invention may take place in association with a communication media and/or other electronic media.

In one non-limiting example, the present system may be used in an academic environment or other educational setting. The first step in such embodiments of the present invention is to provide development training for instructors within an academic environment, such as a school district. These professionals are trained by accessing, via the Internet, audio or video presentations on topics of interest, such as leadership training, math skills, communication skills, English skills, and similar subjects of consequence and importance to the professional development of educational instructors. These topics for professional development may also be dictated by federal or state governmental standards or by the school district itself. The second step in such embodiments it to provide a matrix that automatically conforms to standards set by the state or regional districts where the instructor teaches. Next, the instructors use the matrix to train. The system then enables and assists the instructor to integrate the training into a lesson plan and, ultimately, into classroom instruction. After the instructor teaches students based on the training received, students of the instructor may then be assessed using any standardized examination. The data from these examinations assesses and analyzes students at all levels and at all demographics and may be forwarded to an administrator or supervisor of the instructor and used in the instructor's evaluation, either by a supervisor of the instructor, or simply by the instructor for his or her own self-assessment. If the assessment reveals students of the instructor are deficient in certain areas, this signals the instructor may need more training in those areas. The instructor may then participate in additional development training, which begins the cycle anew.

In such educational embodiments, the instructor's participation in the training may be monitored and the system may provide self-evaluation examinations so that the instructor may determine whether or not the instruction has been integrated. In some embodiments, the system provides that once a level of comprehension is attained, the instructor may then move to the matrix or template that assists the instructor in completing and designing instructional lesson plans. These lesson plans integrate the training the instructor just received. The ultimate purpose of the lesson plan matrix is to guide the instructor in creating instructional lesson plans that comply with standards set by the federal and state governments. Also integrated into the lesson plan design and the applied classroom instruction are the skills learned by the instructor during the development training. Put another way, the professional development concepts and strategies all become part of the pedagogy.

Further, in such educational embodiments, after a period of time elapses, in which these newly trained skills are implemented and utilized, students under the purview of the instructor are given standardized examinations, such as CRT, SAT, or MAT. The assessment data derived from these tests is then analyzed at all levels of comprehension and then correlated with student demographics. This analysis is then provided to the instructor for instructor self-assessment or may be provided to the administrator for instructor review and advancement decisions. If the assessment reveals the training resulted in an improvement in student performance, then the school district or supervisor may provide refresher training, more complex training in that area, or may expand the training into additional areas of training, which are thought to be needed. If the assessment analysis demonstrates in specific areas of training there was no net improvement, then those areas may either be deleted from the training program, replaced with other standards shown to be successful, or more training may be made available.

In another educational embodiment, the present invention may be practiced by providing training to an instructor over the Internet. After the instructor has completed the training, the instructor is then presented with a first set of questions pertaining to the training. Again, the first set of questions is provided via the Internet. In such embodiments, the questions are prepared in advance and provided according to the specific training previously completed. The instructor then teaches students based on the training received. Afterward, additional follow-up questions may be generated automatically and a second set of questions selected from the additional follow-up questions may subsequently be submitted to the instructor and/or his or her supervisor.

In such educational embodiments, the instructor's teaching may be monitored via the Internet to assess the instructor's performance both before and after receiving the Internet based training. If the responses to the question sets provided and the assessment of the instructor's implementation of the training reveal that the instructor is deficient in certain areas, this signals that the instructor may need more training in those areas. The instructor may participate in this cycle repeatedly as necessary.

Accordingly, some embodiments of the present invention may be utilized in association with a training system to assist in the development of professionals in discrete areas of instruction. These areas of instruction may be those mandated by federal or state regulations or simply may be in areas where organizations feel their instructors or trainees need improvement.

Other embodiments of the present invention may be utilized in association with a system for professional development where there is supervision of instructors to ensure they meet and implement federal, state or local standards.

Still other embodiments of the present invention may be utilized in association with a system for professional development where there is guidance available for instructors as to how to implement federal, state or local standards.

In some embodiments, this information may be shared between school districts in a region so that successful concepts may be widely integrated.

By way of other non-limiting examples, the present system may also be used for training professionals in areas outside academia. For example, as mentioned previously, the present invention may be used to improve the skills of health care professionals such as nurses or physicians, legal professionals such as lawyers, judges or trustees, corporate professionals such as officers, directors, managers or other internal corporate employees, travel industry professionals such as pilots, drivers, skippers or the like, educational professionals such as teachers or professors, financial professionals such as accountants, brokers, traders, tax specialists or the like, human relations professionals, sales professionals, service industry professionals, government employees, or any other workforce that requires professional training and assessment as to the assimilation and effectiveness of such training.

More particularly, in another specific non-limiting example, the present invention may be practiced by providing training to a corporate manager, officer or director via the Internet. After the corporate professional has completed the training, the corporate professional is then presented with a first set of questions via the Internet which pertain to the training. In such embodiments, the questions are prepared in advance and provided according to the specific training previously completed. The corporate professional then implements the principles and concepts of the training received in carrying out his or her corporate responsibilities. Afterward, additional follow-up questions may be generated automatically and a second set of questions selected from the additional follow-up questions may subsequently be submitted to the corporate professional and/or his or her supervisor.

In such corporate embodiments, the corporate professional's execution of specific responsibilities may be monitored via the Internet to assess the corporate professional's performance both before and after receiving the Internet based training. If the responses to the question sets provided and the assessment of the corporate professional's implementation of the training reveal professional deficiencies, this signals that the corporate professional may need more training. The corporate professional may participate in this cycle repeatedly as necessary.

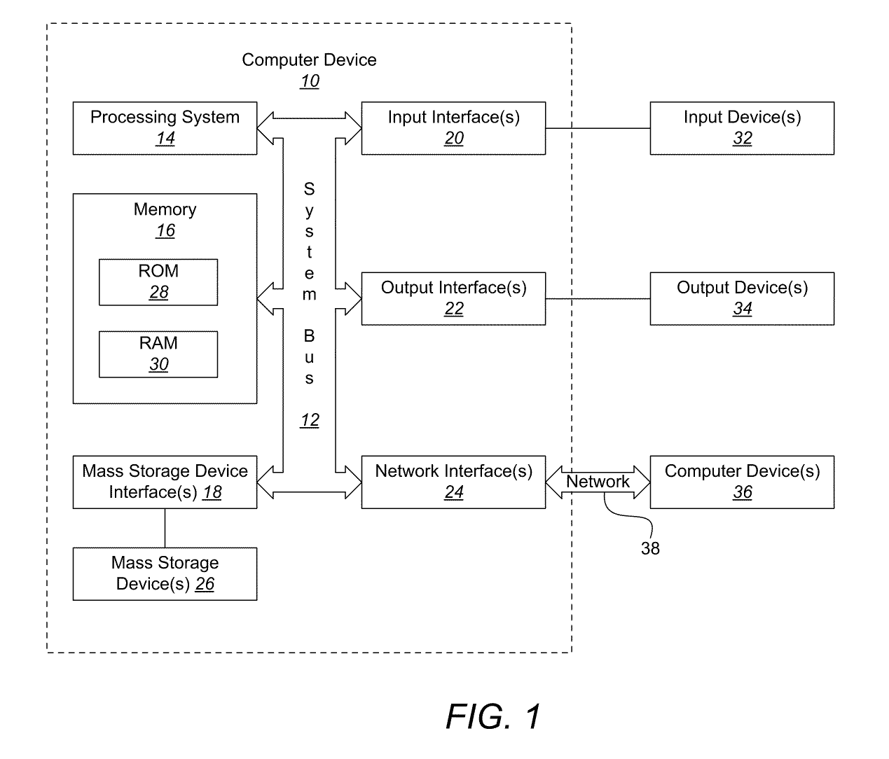

Turning to the figures, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device, which is configured to perform multi-colorant rendering.

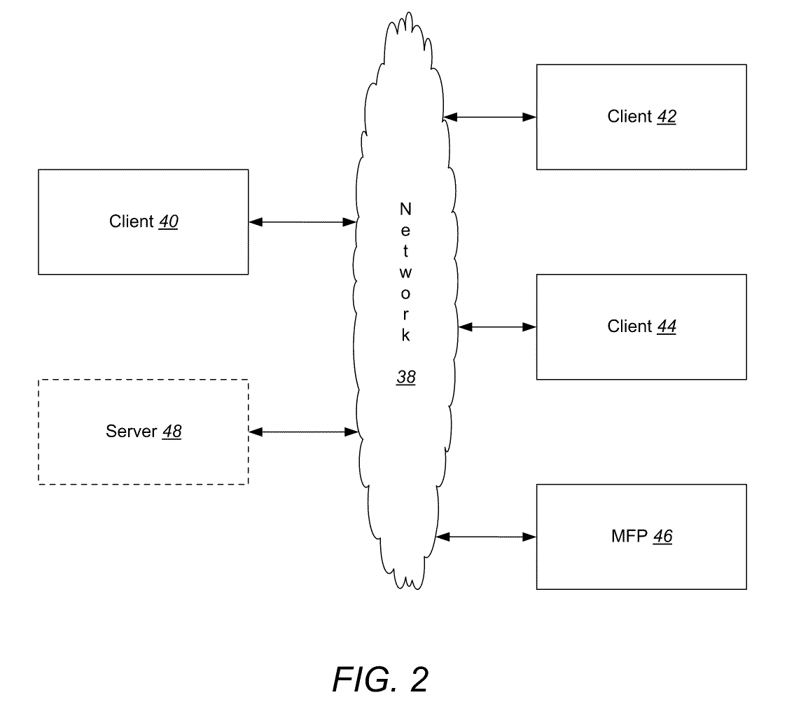

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

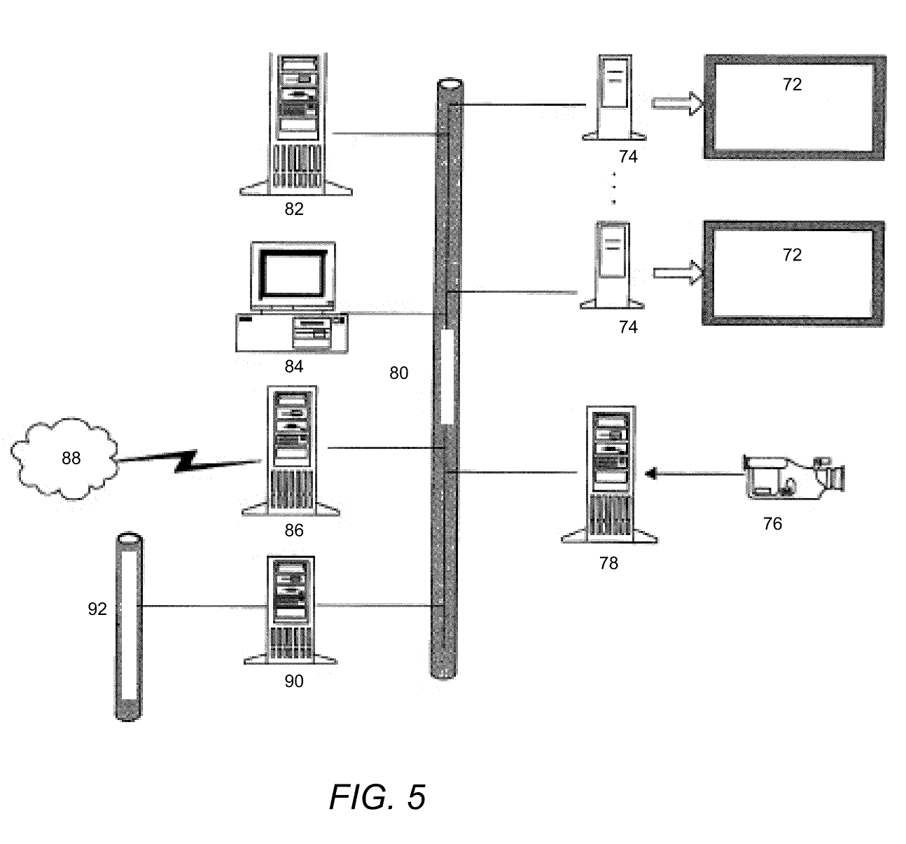

Turning briefly to FIG. 5, some embodiments of this system allow an operator to direct training on a network of many display controllers 74 simultaneously. Similar to computer device 10 previously discussed, display controller 74 may be a general purpose or special purpose computer or any of a variety of consumer electronic device such as a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like. The display controllers 74 can be connected to a local or a remote network 80 via hardwire and/or wireless links similar to the computer devices 10 discussed above. Examples of such hardwire connections and wireless links may include 10BASE-T, 100BASE-TX, 1000BASE-T, dial-up, ISDN, XDSL, ADSL, DSL, SDSL, Wi-Fi, broadband, and the like. Collectively, these connections are called the secured network 80 as all transmissions may be verified through security software contained in the network interface that receives and transmits the information on the devices. A plurality of training units may be controlled by one server 82 that an operator accesses through the system interface 84. (As used herein, display units 72 represent any type of output device capable of communicating via display, transmission, broadcast or other dissemination of any type of communicative message, information, graphic or photographic content, indicia, etc.)

In such an embodiment, there is a hierarchy of servers, each of which can control a plurality of training units with the servers having control and information channels directly to each other via the secure network 80. Having this hierarchy provides a way for an operator to control the entire system of training units at and below the level they access the secured network 80 using the system interface 84.

The system contains a minimum of five major parts: a server 82, system interface 84, display controller 74, secure network 80, and a display unit 72. Some embodiments also contain three additional gateways that plug into the system; an Internet gateway 86, a data gateway 90, and a streaming video gateway 78. The secure network 80 provides the communication between all the system components.

For some of the applications of the system it is necessary to acquire real-time or real-world data to complete the training information being presented. In these cases, the Internet gateway 86 is used to find specific information on the Internet 88 and format it for use by the system. Internally, the gateway uses a highly configurable Internet data extractor program that is able to find information from specific websites. This mechanism provides the Internet gateway with the means to provide the unsecured data from the Internet to the secured environment of the system.

Some of the information displayed on the system can depend on information present in various databases. The data gateway 90 is used to access this external information. For example, if an operator wants to key training questions to a specific training unit that has been or is being provided, the database can be queried to find out what training questions are available for a specific training unit. This type of application requires the data gateway 90. Internally, the gateway contains a data extractor that can query information on various databases via the data network 92. It then takes this information and changes it into secured information that the Server 82 can use via the network interface 84.

In some cases, live events will be shown on the training network. By using the streaming video gateway 78, this live content can be channeled to any display unit 72 on the network that is set up to receive this type of transmission from any video source 76. This makes it possible to show important or special training events without having to have the content already present on the display controller, as may be the case with other media.

Ultimately, the server 82 is the central communication point for the network of display controllers 74. All control and communication with the system is done through the server 82 using the secured network 80. When updated with the system interface, all of these components are sent to the display controllers via the secured network. The server 82 may contain several components that work together to complete the server's tasks including a media manager (not shown), a dynamic data manager (not shown) and a network interface (not shown). The server 82 is also the central repository of information about the training network that it controls. Accordingly, an operator can control the entire training network, including training unit presentations and subsequent series of questions and so forth as discussed in greater detail below, via the server 82.

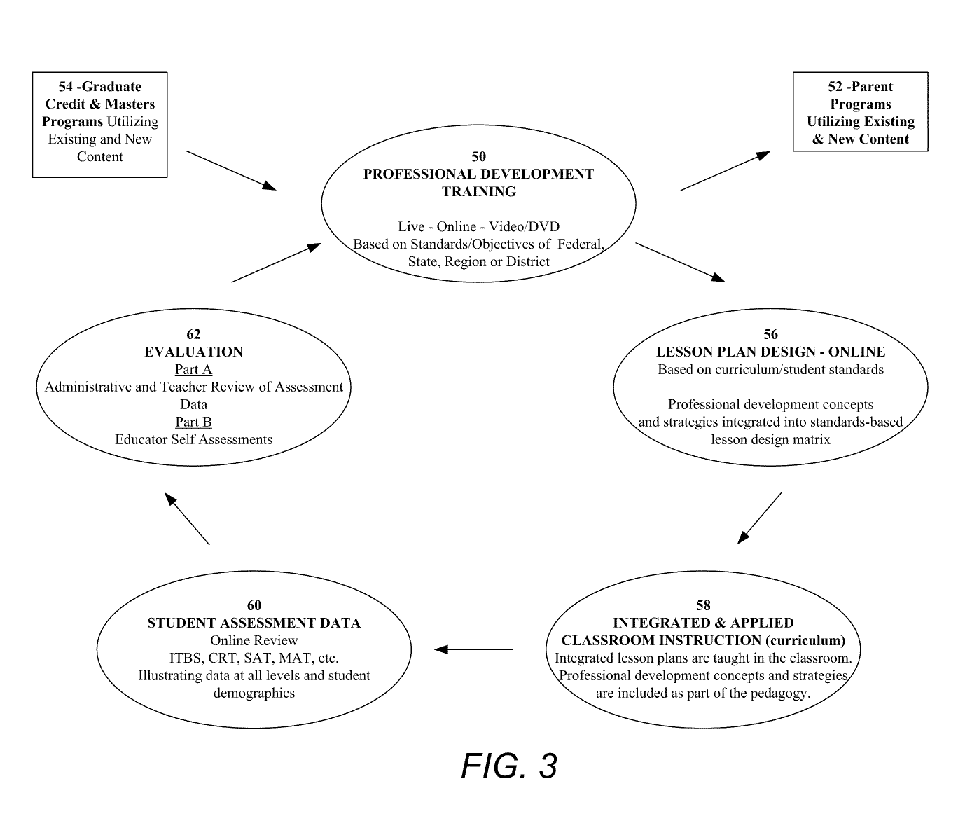

Referring now to FIG. 3, a representative embodiment of the present invention is depicted in a flow chart format. In FIG. 3, professional development training 50 is provided comprising a combination of live, on-line, and video presentations directed to specific areas of improvement. For example, in an educational context, these areas of improvement may correspond to standards set forth by a school district or a group of parents, such as the Parent Teacher Association. In a broader context, the areas of improvement may be aimed at and correspond with standards set forth by the private entity providing the training, or, if a public entity, by the federal or state government.

As set forth in an academic setting, this professional development training 50 may also be accessed through parent programs 52, in which parents may monitor the training being provided by instructors and may offer feedback on areas where parents believe further training is required. The parents may also participate themselves in the programs so that they may support the instructors and supplement the instruction being offered their children.

Further, college students pursuing education degrees, graduates of education, and masters' students preparing to be educational instructors may also go through program 54, where they receive professional development training either for the purpose to improve the likelihood of being hired by a school district, because their training is customized to conform with that particular school districts standards and style, or because the school district also mandates a potential applicant instructor undergo such training before the instructor is considered for the job and hired.

After an instructor proceeds through a unit of professional development training 50, the instructor may take a self-assessment examination to determine whether or not the training has been comprehended and integrated. When the instructor is satisfied with his or her comprehension of the training unit, the instructor then may access an on-line lesson plan development matrix 56 that guides the instructor through the creation of lesson plans. These lesson plans conform with standards applicable to that instructor and to local or national standards.

After creating the lesson plan or plans, the instructor then applies the training from the professional development training unit by integrating the concepts in that unit into the lesson plans. These integrated lesson plans 58 are used by the instructor so that the professional development concepts and strategies are included as part of the pedagogy.

The professional development training 50 units may be available on-line, through videotapes, digital versatile discs (DVDs), MP4s, MP3s, and all other digital media forms and may be accessed throughout the school year so that the concepts may be refreshed in the minds of the instructor. At the end of some period of assessment, for example, after a quarter or semester, students are given an assessment examination, such as the ITBS, CRT, SAT, or MAT that creates student assessment data 60. This student assessment data 60 is analyzed to determine whether or not a student's scores have improved from previous assessment base-line data and whether or not that improvement data may be attributed to the training. If there is an improvement in the student assessments that can be attributed to the instructor's training, then that training may be refreshed each year or more difficult or more complex training principles may be introduced the next year. The cycle may continue until there appears to be no added improvement resulting from the additional training. Successful training may also be communicated to other school districts so that they can take advantage of the research of other school districts. Student assessment data may not only be used for the educator's self-assessment, but also may be forwarded for administrative and teacher review 62.

In an alternative example, professional development training 50 may be provided to corporate professionals comprising a combination of live, on-line, and video presentations directed to specific areas of improvement. In a corporate context, these areas of improvement may correspond to standards set forth by federal, state or local laws and/or by corporate bylaws and articles of incorporation.

As set forth in a corporate setting, this professional development training 50 may also be accessed by investors directly or through brokers, shareholders, or other corporate entities. Similarly, investors, shareholders or other corporate entities may monitor the training being provided and may offer feedback on areas where they believe further training is required. Such third parties may also participate themselves in the training so that they can supplement the instruction being provided.

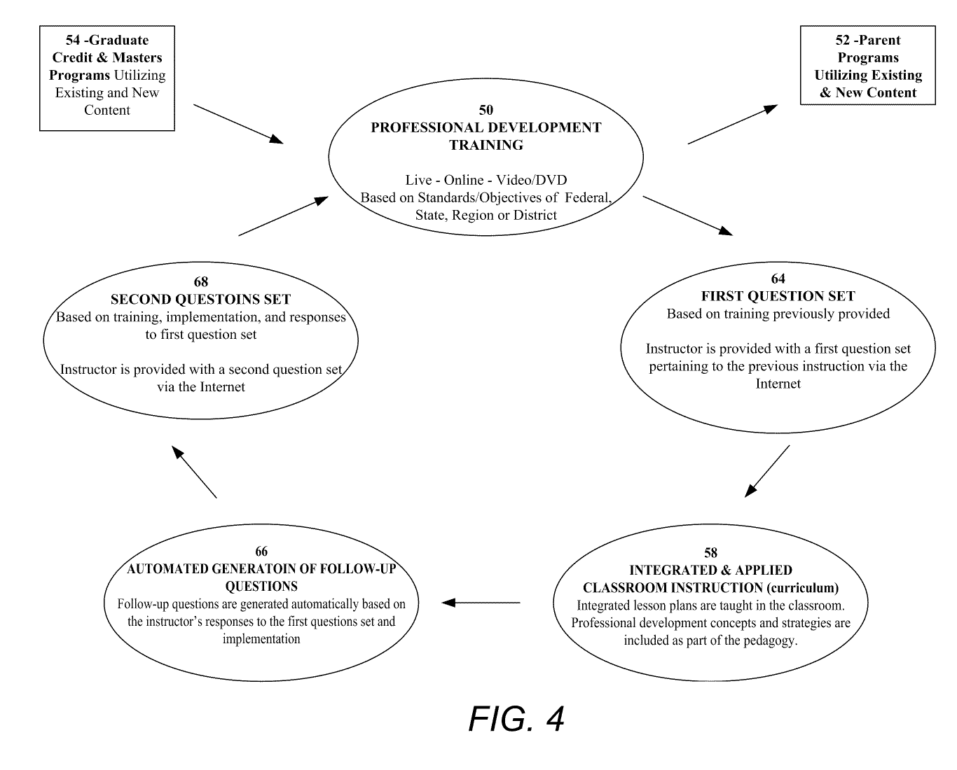

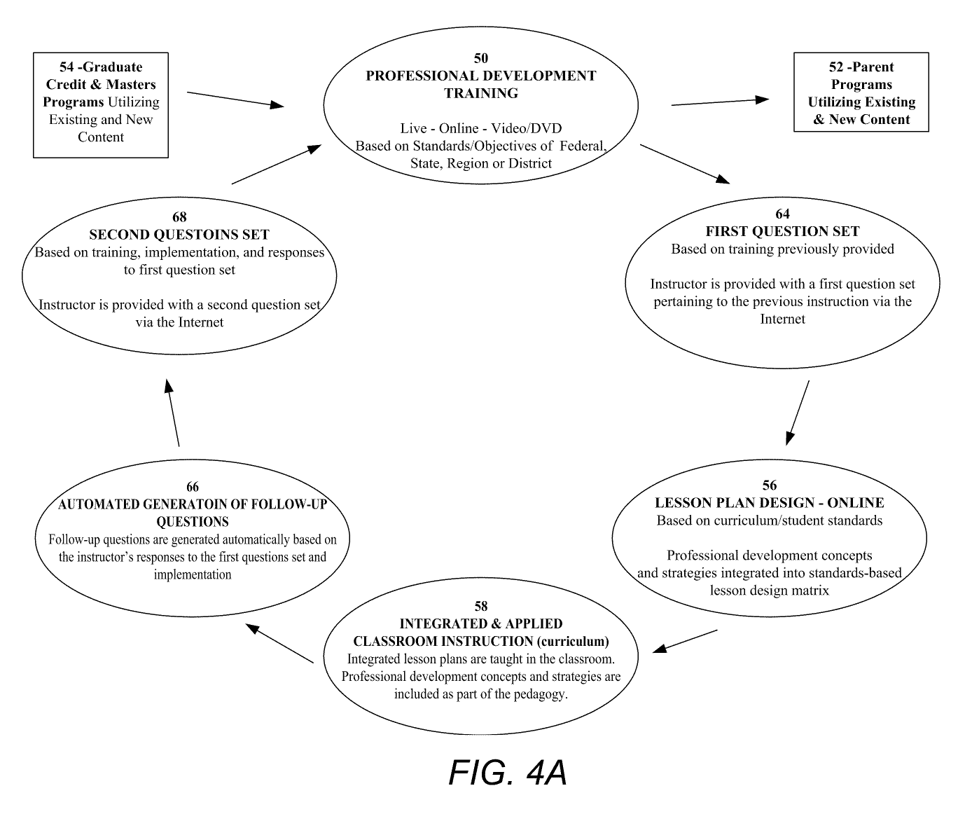

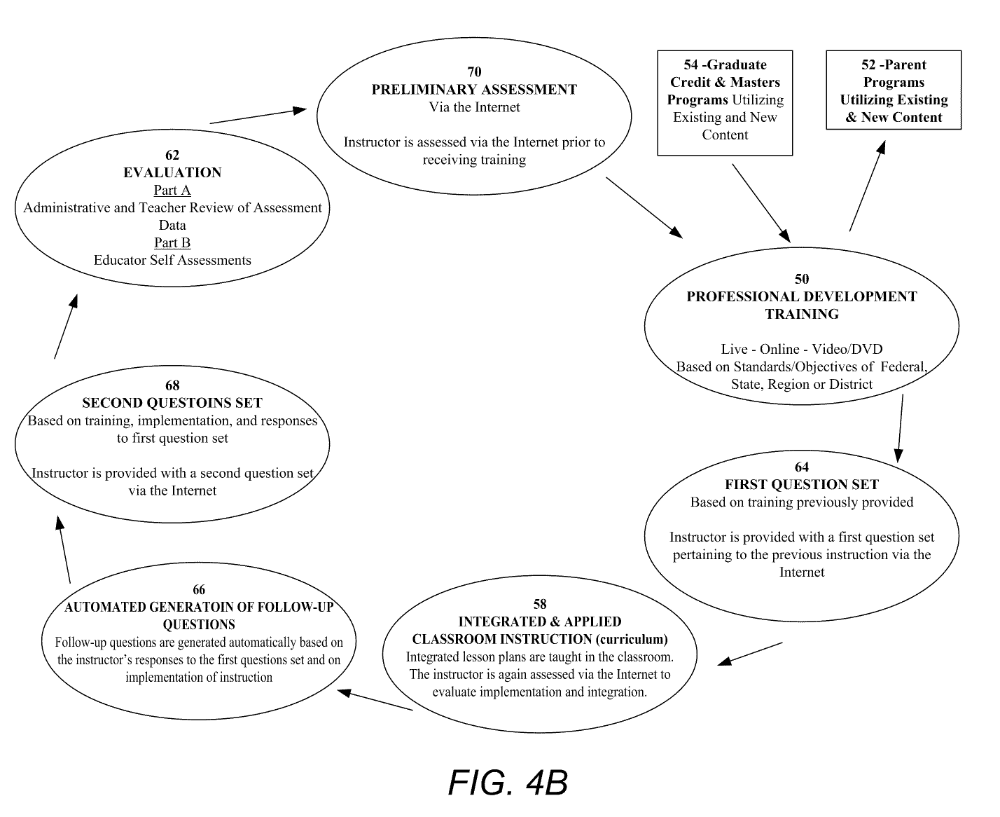

Referring now to FIG. 4, another representative embodiment is illustrated again in a flow chart format. As previously discussed with reference to FIG. 3, professional development training 50 is provided comprising a combination of live, on-line, and video presentations directed to specific areas of improvement. In some embodiments, the professional development training 50 is provided over the Internet. In such embodiments, the professional development training 50 may initially be presented in a variety of different formats each of which is then broadcast via the Internet to remote locations. For example, while the professional development training 50 may be a live presentation, a participant may view and participate in the live presentation over the Internet from a location other than where the live presentation is physically taking place. In such embodiments, webcams, microphones, monitors, speakers, keyboards, mouse devices, and all other similar or equivalent devices may be employed to facilitate the live broadcast. In another example, the professional development training 50 may be in a video, audio or other digital media format which is then streamed over the Internet to remote viewers and participants. In such embodiments, streaming may take place at scheduled times or may be provided on-demand. In still another example, the professional development training 50 may be in a digital media format which is first downloaded by a participant and stored at their remote location for subsequent viewing and/or participation.

In some embodiments, as few as a single participant may receive and participate in the professional development training 50 over the Internet at any given time. In alternative embodiments, multiple participants may receive and participate in the professional development training 50 simultaneously. In still other embodiments, an unlimited number of participants may be involved.

In a further embodiment, participants in the professional development training 50 received over the Internet may receive informational segments. In such embodiments, training may be provided in installments or segments. More specifically, a professional development training covering a particular area of improvement may be provided in several discrete segments or parts. As a given segment is satisfactorily completed, the next segment is made available. For example, a training topic such as mathematics may include multiple parts, such as five (5) parts. Part one (1) would need to be completed at a satisfactory level before Part two (2) would become available and so forth. In this way, the participant is able to assimilate or digest the information presented in more manageable pieces. In such embodiments, a participant may be scheduled to complete various segments at specific times or a participant may be allowed to complete the various segments at a self-induced pace.

Again, as discussed with reference to FIG. 3, in educational embodiments, the areas of improvement previously discussed may correspond to standards set forth by a school district, a group of parents, a private entity providing the training, or the federal or state government. In such embodiments, the participants may be professional instructors. Accordingly, these areas of improvement may include professional training covering skills, knowledge, proficiency, and other competency requirements in accordance with measureable standards of learning for the students a given instructor teaches. Alternatively, in corporate embodiments, the areas of improvement previously discussed may correspond to standards set forth by corporate bylaws and/or articles of incorporation or the federal, state or local government. In such embodiments, the participants may be corporate professionals, such as directors, officers, managers, and shareholders. Accordingly, these areas of improvement may include professional training covering skills, knowledge, proficiency, and other competency requirements in accordance with measureable standards of corporate management.

All other features and aspects associated with the professional development training 50 previously discussed may or may not be included in any given embodiments of the present invention. Specifically, various embodiments may, but need not, also include parent programs 52 as discussed above. Similarly, various embodiments may, but need not, also include graduate programs 54 also discussed above.

With continued reference to FIG. 4, after the professional development training 50 is provided to a participant, first question set 64 is then provided via the Internet to the participant. In some embodiments, the first question set 64 is provided at the conclusion of the entire professional development training. In other embodiments, first question set 64 may be provided in between training installments and may itself be broken-up into multiple installments corresponding to the associated training.

In some embodiments, the first question set 64 may be based on the training previously provided. For example, a training topic such as mathematics may be followed by a first question set 64 about mathematics. Alternatively, a training topic such as the duty of loyalty may be followed by a first question set 64 about the duty of loyalty. In such embodiments, the first question set 64 may query a given participant about the substance of the training provided. In other embodiments, the first question set 64 may be about the format of the training presented or other similar questions about the efficacy of the training itself. In still other embodiments, the first question set 64 may be indirectly related or even totally unrelated to the training previously provided.

To accommodate providing first question set 64, an electronic storage media may be provided. The electronic storage media may include computer readable media or mass storage devices and their attendant components and interfaces as discussed previously with reference to FIG. 1. A first bank of questions may then be generated in advance and stored on the electronic storage media. The first question bank may include all the questions associated with the several different topics of instruction or areas of improvement contemplated by the present invention. The first question set 64 may then be selected from the first question bank according to the training previously provided or according to other objectives. After the first question set 64 is selected from the first question bank, the questions may automatically be delivered via the Internet to a training participant or multiple training participants. In embodiments contemplating multiple participants, the first question set 64 may be the same for each participant or each participant may receive a unique first question set 64 according to his or her individual progression or objectives.

With continued reference to FIG. 4, after the first question set 64 is provided to a participant via the Internet, the participant then applies the training from the professional development training unit. In some embodiments contemplating an education application, the participant instructor applies the training by integrating the concepts and principles in that unit into a lesson plan 58 as previously discussed. These integrated lesson plans 58 are used by the instructor so that the professional development concepts and strategies are included as part of the pedagogy. In this way, the skills, knowledge, and proficiency of the instructor may be enhanced and the improvements incorporated into classroom instruction. In alternative embodiments contemplating a corporate application, the participant applies the training by integrating the concepts and principles in that unit into the exercise of specific corporate responsibilities. In this way, the skills, knowledge, and proficiency of the corporate professional may be enhanced and the improvements incorporated into corporate management.

After the integrated and applied classroom instruction 58 has occurred, or after some other predetermined time period has elapsed, additional follow-up questions are automatically generated at 66. In some embodiments, the follow-up questions may be generated from scratch. In such embodiments, the follow-up questions may be based on the participant's responses to the first question set 64. Alternatively, the follow-up questions may be based on the participant's implementation or application of the training from the professional development training unit. In still another alternative, the follow-up questions may be based on the subject matter or topic covered in the professional development training unit. In other embodiments, the follow-up questions may be selected from the first question bank previously discussed from which the first question set 64 was selected. In such embodiments, some or all of the follow-up questions may be the same or different than those selected for the first question set 64. Automatic generation of the follow-up questions is facilitated by use of a computer device and/or network configuration as previously discussed with reference to FIGS. 1 and 2.

After the follow-up questions are automatically generated at block 66 as discussed above, second question set 68 is then provided via the Internet. In some embodiments, the second question set 68 may be provided directly to the training participant. In other embodiments, the second question set 68 may be provided to a supervisor of the training participant or multiple supervisors, managers, directors, officers, and the like. In still other embodiments, the second question set 68 may be provided to other interested third parties. For example, in educational embodiments, the second question set 68 may be provided to parents of the students the participant instructor teaches. As an alternative example, in corporate embodiments, the second question set 68, may be provided to investors, brokers, shareholders, and the like.

In some embodiments, the second question set 68 is provided at the conclusion of the implementation or integration of the professional development training. In other embodiments, second question set 68 may be provided at various intervals over a longer period of time during which the principles or concepts of the professional development training are continuously implemented and re-implemented as necessary.

As with the first question set 64, the second question set 68 may be based on the training previously provided. Similarly, however, in other embodiments, the second question set 68 may be indirectly related or even totally unrelated to the training previously provided. In still other embodiments, the second question set 68 may be based on the participant's responses to the first questions set 64 or the participant's implementation of the principles and concepts of the training unit.

Similar again to first question set 64, providing second question set 68 contemplates providing an electronic storage media. The electronic storage media associated with the second question set 68 may be the same or different than that associated with the first question set 64. A second bank of follow-up questions may then be generated according to the previous discussion with reference to 66 and stored on the electronic storage media. The second question bank may include all the follow-up questions associated with the several different topics of instruction or areas of improvement contemplated by the present invention. In such embodiments, the second question bank may include follow-up questions that were generated previously for former participants. Alternatively, the second question bank may only include the follow-up questions that were generated for the instant participant. The second question set 68 may then be selected from the second question bank according to the training previously provided, the participant's responses to the first question set 64, the participant's implementation of the principles and concepts of the training unit, or according to other objectives.

After the second question set 68 is selected from the second question bank, the questions may automatically be delivered via the Internet to a training participant or multiple training participants. Alternatively, the questions may automatically be delivered via the Internet to a supervisor of the participant as discussed above. In embodiments contemplating multiple participants and/or supervisors, the second question set 68 may be the same for each participant/supervisor or each participant/supervisor may receive a unique second question set 68 according to his or her individual progression or objectives.

The training cycle depicted in FIG. 4 may continue repeatedly as necessary. In some instances the same training materials may be provided repeatedly or as necessary while in other instances additional or different training materials may be provided.

With reference now to FIG. 4A, the representative embodiment illustrated in FIG. 4 is again provided but FIG. 4A includes an additional segment in the improvement continuum integrating the system of the current invention. After a participant, such as an instructor, proceeds through a unit of professional development training 50 and receives and responds to the first question set 64, the participant may take a self-assessment examination to determine whether or not the training has been comprehended and integrated. When the participant is satisfied with his or her comprehension of the training unit, the participant then may access an on-line lesson plan development matrix 56 that guides the participant instructor through the creation of lesson or instructional plans. These lesson plans conform with standards applicable to that instructor and to local or national standards. Further, the lesson plan may be based on skills and knowledge acquired by the participant instructor during the training. Similarly, corporate participants may access alternative on-line development matrices to assist them in application of training principles and concepts.

Both the professional development training 50 and the instructional or lesson plan development matrix 56 may include video, audio or digital media information designed to enhance participant proficiency. However, the initial training and the subsequent matrix may also include interactive web-based activities, workbooks, worksheets, programs, images, exercises, games, and the like designed to reinforce various training presentations. Further the web-based features of both the training and matrix may assist the participant in implementing the training previously received in subsequent teaching or instruction.

The training cycle depicted in FIG. 4A may continue repeatedly as necessary. In some instances the same training materials may be provided repeatedly or as necessary while in other instances additional or different training materials may be provided.

Referring now to FIG. 4B, another representative embodiment is illustrated again in a flow chart format. In FIG. 4B preliminary assessment 70 is provided. In some embodiments, the preliminary assessment 70 is conducted via the Internet prior to providing any professional development training. In such embodiments, a participant's performance is initially evaluated in order to determine areas in which the participant may require additional training. Based on the preliminary assessment 70, an appropriate training is subsequently selected.

The process proceeds through professional development training 50 and the presentation of first question set 64 as described above. At block 58, however, the participant is again assessed via the Internet to evaluate implementation and integration of the principles and concepts learned in the professional development training. Again, the process continues through the automated generation of follow-up questions 66 and the presentation of second question set 68 as discussed above.

At 62 the participant is evaluated. In some embodiments, participant evaluation 62 may be based on student assessment data 60 as described previously with reference to FIG. 3. In other embodiments, participant evaluation 62 may be based on the participant's responses to the first and second question sets previously provided and on the participant's implementation of the principles and concepts learned in the professional development training. In such embodiments, the performance of the participant before the training, as observed during the preliminary assessment 70, can be compared to the post-training performance of the participant observed at 58. Accordingly, the evaluations can be used by the participant or a supervisor of the participant to subsequently modify or improve the participant's proficiency. To further accommodate such improvement, the evaluations generated by the system of the present invention may be printed and sent directly to the participant or the participant's supervisor. The printed evaluations may provide a break-down of several different competency areas in which the participant was evaluated to further facilitate participant improvement.

At the end of some period of assessment the participant is evaluated at 62 to determine whether or not the participant has improved and whether or not that improvement may be attributed to the training. If there is an improvement in participant performance that can be attributed to the training, then that training may be refreshed each year or more difficult or more complex training principles may be introduced the next year. The cycle may continue until there appears to be no added improvement resulting from the additional training. Successful training may also be communicated to other entities and in other industries so that they can take advantage of successful methods. Participant assessment data may not only be used for the participator's self-assessment, but also may be forwarded for administrative review 62.

In some implementations, the present invention may be employed on a computer system or in connection with a networked system as discussed with reference to FIGS. 1, 2, and 5. Accordingly, some aspects of the present invention may take place in association with computer devices, computer readable media, mass electronic storage devices, processing systems, servers, and any necessary interfaces to accommodate such systems Likewise, some aspects of the present invention may take place in association with a communication media and/or other electronic media.

In many parts of the country, so-called “high stakes testing” are used wherein the salary, advancement, or continued employment of an instructor is based on standardized student assessment. Embodiments of the present invention provide evaluation standards to be used by an administrator so that such decisions can be based upon verifiable and quantifiable criteria. The evaluation process may also be used to determine which areas of professional development training need to be revisited by an instructor or introduced into the system. For example, if math scores are low, and other school districts have experienced success in implementing a communication skills professional development training, which seems to have improved math scores, then the administrator may place that unit into the mandatory curriculum for instructors.

It will be appreciated that the professional development training system set forth above may also be utilized for any private or public entity training, and not just for educational training. By way of an additional non-limiting example, the Occupational Safety and Health Administration (OSHA) or similar federally mandated safety training entity may be taught using the embodiments of the present invention herein described. Specifically, instructors or trainees may be trained on-line through video/DVD capabilities of the present invention, and personal assessments may be used to determine whether or not the concepts have been comprehended. A plan may also be developed for incorporating the professional concepts and strategies into the workflow and daily regiment for the professional. Evaluation and assessment data may then be provided an administrator or a supervisor of the trainee/professional to verify that concepts have been successfully integrated.

Thus, as described herein, embodiments of the present invention embrace professional development training. In particular, the present invention relates to systems and methods for providing professional development training to persons employed in diverse industries to thereby improve the professional's knowledge, skills, and proficiency.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A method for professional development, said method comprising the steps of:
providing training to a professional over the Internet;
querying said professional over the Internet about said training at the conclusion of said training using a first set of questions;
allowing said professional to implement principles of said training previously provided in executing said professional's professional responsibilities; and
generating additional automated follow-up questions.

2. The method of claim 1, further comprising the step of querying said professional over the Internet using a second set of questions selected from said additional automated follow-up questions.

3. The method of claim 1, further comprising the step of querying a supervisor of said professional over the Internet using a second set of questions selected from said additional automated follow-up questions.

4. The method of claim 1, wherein said providing training further comprises teaching skills in accordance with measurable industry standards.

5. The method of claim 1, wherein said training over the Internet further comprises receiving informational segments over the Internet.

6. The method of claim 1, wherein said training is professional development training.

7. The method of claim 1, wherein said training is provided on-line.

8. The method of claim 7, wherein said on-line training comprises audio, video, or DVD training.

9. The method of claim 1, wherein the step of querying said professional over the Internet about said training at the conclusion of said training using said first set of questions further comprises the steps of:
providing an electronic storage media;
generating questions in advance to be stored on said electronic storage media; and
selecting said first set of questions from said previously generated questions stored on said electronic storage media to deliver to said professional over the Internet based on said training previously provided.

10. The method of claim 1, wherein the step of allowing said professional to implement principles of said training previously provided in executing said professional's professional responsibilities is preceded by the step of enabling said professional to organize a plan relating to said training, wherein said plan is based on skills and knowledge acquired by said professional from said training.

11. The method of claim 10, wherein the step of enabling said professional to organize said plan relating to said training further comprises allowing access over the Internet to a development matrix for said training, wherein said matrix incorporates said skills and knowledge learned in said training into said plan for said professional undergoing said training.

12. The method of claim 1, wherein the step of generating additional automated follow-up questions is preceded by the step of waiting for a predetermined period of time.

13. The method of claim 4, further comprising the steps of:
assessing success of said training in improving professional skills of said professional; comprising:
testing individuals overseen by said professional in a professional capacity according to said measurable industry standards; and
analyzing and correlating results of said testing according to said measurable industry standards; and
printing evaluations of the success of said training by comparing the performance of said individuals before and after said training, said evaluations to be used by said professional to modify behavior of said professional.

14. The method of claim 1, wherein the step of generating additional automated follow-up questions further comprises use of a computer device.

15. The method of claim 14, wherein the additional automated follow-up questions are generated based on said professional's responses to said first set of questions and on said training previously provided.

16. The method of claim 2, wherein the step of querying said professional over the Internet using a second set of questions selected from said additional automated follow-up questions further comprises the steps of:
providing an electronic storage media;
storing said additional automated follow-up questions previously generated on said electronic storage media; and
selecting said second set of questions from said previously generated automated follow-up questions stored on said electronic storage media to deliver to said professional over the Internet based on said training previously provided.

17. The method of claim 3, wherein the step of querying said supervisor of said professional over the Internet using a second set of questions selected from said additional automated follow-up questions further comprises the steps of:
providing an electronic storage media;
storing said additional automated follow-up questions previously generated on said electronic storage media; and
selecting said second set of questions from said previously generated automated follow-up questions stored on said electronic storage media to deliver to said supervisor of said professional over the Internet based on said training previously provided.

18. The method of claim 2 or 3, further comprising the steps of:
utilizing the Internet to assess said professional's skills prior to receiving said training;
utilizing the Internet to assess said professional's implementation of said training in said professional's execution of said professional responsibilities;
evaluating the effectiveness of said training comprising:
analyzing responses to said first and said second set of questions; and
analyzing said professional's implementation of said training in said professional's execution of said professional responsibilities; and
printing evaluations of the success of said training by comparing the performance of said professional before and after said training, said evaluations to be used by said professional to modify their performance.

19. In a system that includes a computer device, a method for providing professional development training to professionals, the method comprising the steps of:
utilizing the Internet to assess a professional's workplace skills;
providing information to said professional over the Internet based on said assessment previously conducted;
utilizing the Internet to provide said professional with a first set of questions about said information;
allowing said professional to implement principles of said training previously provided in executing said professional's professional responsibilities;
utilizing the Internet to assess said professional's implementation of the information in said professional's execution of said professional responsibilities;
generating additional automated follow-up questions;
utilizing the Internet to provide said professional with a second set of questions selected from said generated additional automated follow-up questions based on said information previously provided, said professional's responses to said first set of questions, and said assessment of said professional's implementation of the information in said professional's execution of said professional responsibilities;
evaluating the effectiveness of said providing information comprising:
analyzing said professional's responses to said first and said second set of questions; and
analyzing said professional's implementation of said training in said professional's execution of said professional responsibilities; and
printing evaluations of the success of said providing information by comparing the performance of said professional before and after said providing information, said evaluations to be used by said professional to modify their professional performance.

20. A system to provide and evaluate professional development training, said system comprising:
a communication media for providing training to at least one professional over the Internet;
a first database for storing a first question set based on said training;
a first electronic media for querying said professional via the Internet using said first question set;
a streaming video gateway and a video source for monitoring said professional's implementation of principles of said training in executing said professional's professional responsibilities;
a second electronic media for automatically generating follow-up questions based on said professional's responses to said first question set, said professional's implementation of said principles of said training in executing said professional responsibilities, and subject matter of said training; and
a second database for storing said follow-up questions, wherein said second electronic media subsequently queries said professional via the Internet using a second question set selected from said follow-up questions stored on said second database.
